(19) United States
(12) Patent Application Publication
(10) Pub. No.: US 2012/0229287 A1
(43) Pub. Date: Sep. 13, 2012

(54) GAS MONITORING SYSTEM

(76) Inventor: Lorne Schuetzle, Dunmore (CA)

(21) Appl. No.: 13/392,741

(22) PCT Filed: Aug. 31, 2010
(86) PCT No.: PCT/CA2010/001363

§ 371 Date: May 30, 2012

Related U.S. Application Data
(60) Provisional application No. 61/238,574, filed on Aug. 31, 2009.

(51) Int. Cl. G08B 21/12; G01N 7/00; E21B 47/00

(52) U.S. Cl. 340/632; 175/40; 73/23.2

(57) ABSTRACT

A system for monitoring the amount of a selected gas in a gas flow is provided comprising a gas sensor for sensing the selected gas in the gas flow and producing a corresponding electrical signal; at least one pressure regulator to adjust a pressure of the gas flow to a standardized pressure before the gas flow reaches the gas sensor; a flow adjustment device to adjust a flow rate of the gas flow to a standardized flow rate before the gas flow reaches the gas sensor; and a controller for receiving the electrical signal from the gas sensor and processing the electric signal to calculate the concentration of the selected gas in the gas flow.

This application claims priority to U.S. provisional patent application No. 61/238,574 filed Aug. 31, 2009.

### FIELD OF INVENTION

The present invention relates to a method and system for monitoring the concentration of a selected gas such as a hydrocarbon gas in gas flows and more particularly to monitoring the amount of the selected gas in gas flows using gas sensors such as infrared gas sensors.

### BACKGROUND OF THE INVENTION

Hydrocarbon gases, such as methane, can be problematic if their concentrations become too high in one area. With high enough concentrations, these gases can be hazardous. With a high enough concentration, these gases can become explosive. In situations where hydrocarbon gases may be or may become present in a sufficient concentration to make a hazardous situation or even in cases where it may be desirable to know that hydrocarbon gases are present in significant levels, even if these significant levels are not high enough to create a hazardous situation, it is often desirable to have a relatively good, reliable way of detecting the presence of these gases and monitoring their concentrations. Specifically, while drilling oil or gas wells, the concentrations of hydrocarbon gases, such as methane, can be of vital importance to operators of the drilling rig.

### SUMMARY OF THE INVENTION

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly the drawings and detailed description are to be regarded as illustrative in nature and not as restrictive.

In one aspect, a system for monitoring the amount of a selected gas in a gas flow is provided comprising a gas sensor for sensing the selected gas in the gas flow and producing a corresponding electrical signal; at least one pressure regulator to adjust a pressure of the gas flow to a standardized pressure before the gas flow reaches the gas sensor; a flow adjustment device to adjust a flow rate of the gas flow to a standardized flow rate before the gas flow reaches the gas sensor; and a controller for receiving the electrical signal from the gas sensor and processing the electric signal to calculate the concentration of the selected gas in the gas flow.

In a second aspect, a system for monitoring the amount of a selected gas in at least two gas flows is provided comprising a separate gas sensor for each gas flow for sensing the concentration of the selected gas in each gas flow and producing at a corresponding electrical signal for each gas flow; at least one pressure regulator for each gas sensor to adjust a pressure of each gas flow to a standardized pressure before the gas flows reach their respective gas sensors; a flow adjustment device for each gas sensor to adjust a flow rate of each gas flow to a standardized flow rate before the gas flows reach their respective gas sensors; and a controller for receiving each electrical signal from each gas sensor and processing the electric signals to calculate the concentration of the selected gas in each gas flow.

In a third aspect, a method for continuously monitoring the amount of a selected gas in a gas flow produced during an operation is provided comprising adjusting a pressure of the gas flow to a standardized pressure; adjusting a flow rate of the standardize pressure gas flow to a standardized flow rate; directing the flow rate standardized gas flow into a gas sensor and sensing the concentration of the selected gas in the gas flow to produced at a corresponding electrical signal; and receiving the electrical signal from the gas sensor and processing the electric signals to calculate the concentration of the selected gas in the gas flow.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic illustration of a dual hydrocarbon gas monitoring system;

FIG. 2 is a schematic of the gas detection system controller.

FIG. 3 is a schematic illustration of a drilling step up for reverse circulation drilling of a gas or oil well using the monitoring system of FIG. 1 to monitor for elevated levels of hydrocarbon gas.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

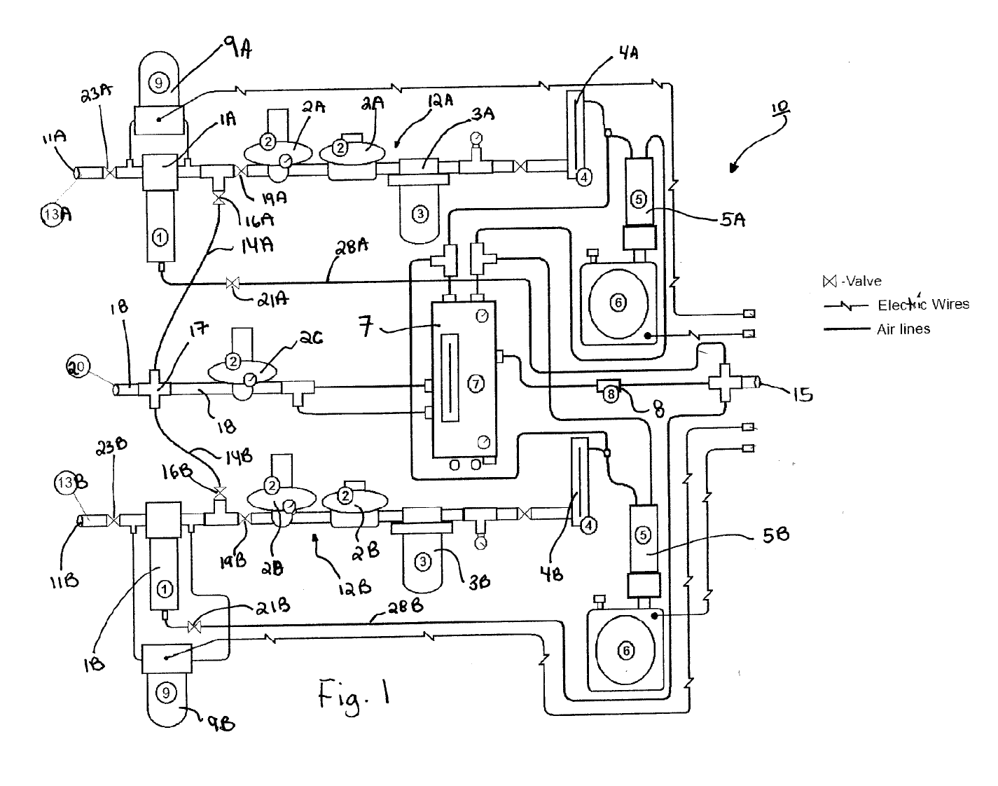

FIG. 1 illustrates a schematic illustration of a dual hydrocarbon gas monitoring system 10 in a first aspect. The system 10 can be used to monitor for the presence and levels of a hydrocarbon gas, such as, but not limited to methane, propane, butane, etc. It is understood that, while FIG. 1 shows a dual monitoring system for measuring hydrocarbon gases from two separate locations, a single gas monitoring system or more than two gas monitoring systems can be used depending upon the particular needs of the user. It is understood that more than one gas monitoring system can be coordinated in order to detect and/or measure gas concentrations at various points according to the user's needs.

The system 10 can have a first testing circuit 12A and a second testing circuit 12B with each testing circuit 12A/12B used to test a separate gas flow for the presence and levels of hydrocarbon gas. The first testing circuit 12A can be used to determine the presence and/or level of hydrocarbon gas in a first gas flow, while the second testing circuit 12B can be used to the determine the presence of and/or level of hydrocarbon gas in a different, second gas flow, allowing the sampling of hydrocarbon gas to be measured from two different gas sources.

The first testing circuit 12A can include a first sample line 13A having a first inlet 11A, a first filter 1A, a first set of pressure regulators 2A, a first water separator 3A, a first flow adjustment device 4A and a first gas sensor 5A. The second testing circuit 12B can include a second sample line 13B having a second inlet 11B, a second set of filters 1B, a second set of pressure regulators 2B, a second water separator 3B, a second flow adjustment device 4B, and a second gas sensor 5B. Each testing circuit 12A/12B can be used to route a separate gas flow through and standardize the pressure and flow rate of the gas flow before it is passed through the infrared sensor 5A, 5B to determine the presence and/or level of hydrocarbon gas in the gas flow.

With reference to the first testing circuit 12A, a first gas flow can be introduced into the first testing circuit 12A through sample line 13A via first inlet 11A. From the first inlet 11A, the first gas flow can be routed by the first sample line 13A through first filter 1A that can be used to remove any contaminants from the first gas flow, for example, any solids such as gravel, drill cuttings, etc. From the first filter 1A, the first gas flow passes through the first sample line 13A to a first series of pressure regulators 2A. The first series of pressure regulators 2A can be used to change the pressure of the first gas flow to a standardized pressure level so that the sampling of a gas flow through the first testing circuit 12A is always done at a constant pressure allowing measured levels of hydrocarbon gases at different times to be relatable to each other based on pressure. Although FIG. 1 shows the first series of pressure regulators 2A consisting of two pressure regulators to reduce the pressure of the first gas flow in two stages, a person skilled in the art will appreciate that more or fewer pressure regulators could be used to effect the standardized pressure of the first gas flow.

Once the first gas flow has passed through the first series of pressure regulators 2A and been altered to the standardized pressure, the first gas flow is passed through a water separator 3A to remove any moisture from the first gas flow and the first gas flow is passed to first flow adjustment device 4A to adjust the flow of the first gas flow to a standardized flow rate. The first flow adjustment device 4A can include a needle valve and a flow meter to adjust the flow rate of the first gas flow to the standardized flow rate.

The first gas flow should now be at the standardized pressure and have the standardized flow rate. The first testing circuit 12A can then pass this first gas flow to the first gas sensor 5A, such as an Optima Plus™ IR sensor, said gas sensor 5A having a connection or junction box 6A. When the gas sensor is an infrared gas sensor (as shown in FIG. 1), the detection (or measurement) of combustible gases with infrared technology relies on the absorption of specific infrared wavelengths by the hydrogen-carbon bonds within the atomic structure of all hydrocarbons. As the concentration of the hydrocarbon increase, so too does the absorption of infrared light in the hydrocarbon “sample” band of the infrared spectrum.

The first infrared gas sensor 5A can use a beam of light to determine the concentration of gas based on the absorption of infrared radiation by the gas as it passes through the first infrared gas sensor 5A. The light beam can be directed at a mirror which reflects the beam of light back to a sensor (not shown) and the time delay for the beam of light to return to the sensor is recorded. If any hydrocarbon gas is present in the first gas flow as it passes through the first infrared gas sensor 5A, the hydrocarbon gas will slow the speed of the light beam, increasing the time delay for the light beam to return to the sensor. The time delay for the traveling of the light beam can be measured by the infrared gas sensor 5A, converted to an electrical signal and transmitted to a control box. Typically, infrared sensors are equipped with standard calibrations for gases such as methane, ethane, propane, butane, and ethylene/ethane. Of course, it is understood that other calibrations for other gases and vapors can generally be purchased from the various sensor manufacturers.

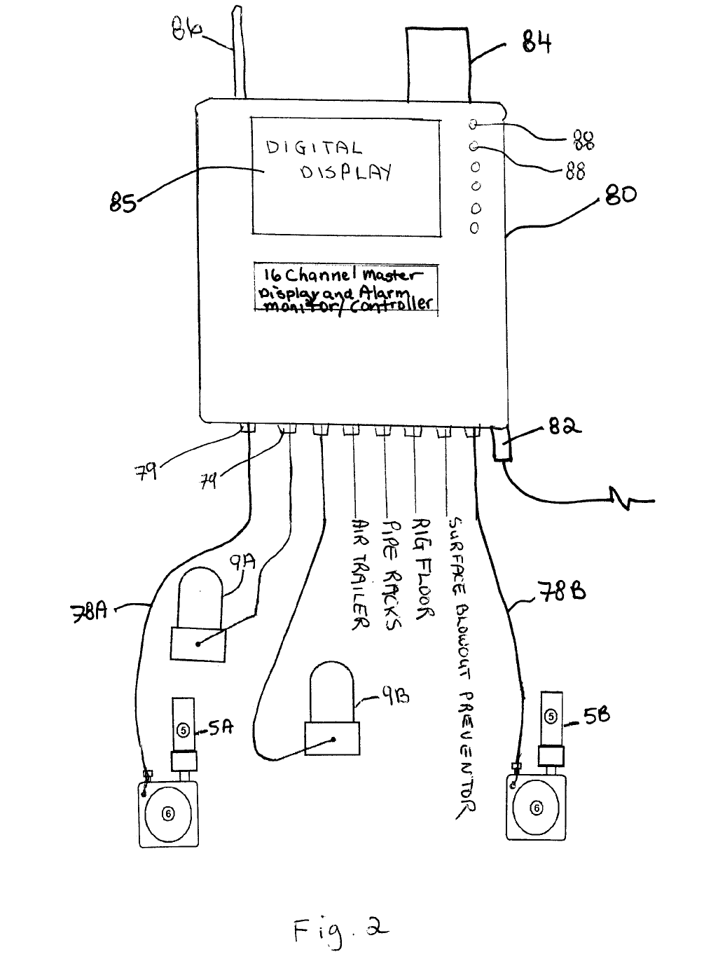

As the first gas flow continues to flow through the first infrared gas sensor 5A, the time delays for the light beam can be determined, converted to electrical signals and transmitted to a control box 80 (as shown in FIG. 2) where the signals (data points) can be stored and/or used to plot a graph, as described in more detail below.

The second testing circuit 12B can operate in the same fashion with a second gas flow. The second gas flow can be introduced into the second testing circuit 12B through sample line 13B via the second inlet 11B where it is routed to the second set of filters 1B to remove any contaminants. Then the second gas flow can be directed to second set of pressure regulators 2B to alter the pressure of the second gas flow to a standardized pressure before removing water from the second gas flow using the second water separator 3B. The second flow adjustment device 4B can be used to alter the flow rate of the second gas flow to a standardized flow rate before the second gas flow having the standardized pressure and the standardized flow rate is passed through the second infrared gas sensor 5B having a connection or junction box 6B.

The second infrared gas sensor 5B can operate in a similar manner to the first infrared gas sensor 5A, passing the second gas flow through a light beam and measuring the time delay for the light beam to reach a senor, converting the time delay to an electrical signal and transmitting the electrical signal to the control box 80 for storing and/or graphing the data.

A vacuum pump 7 can be provided to create a vacuum in the first testing circuit 12A and the second testing circuit 12B at all times to aid the first gas flow and second gas flow in moving through the first testing circuit 12A and second testing circuit 12B, respectively.

In one embodiment, the gas monitoring system of the present invention can be operated by using compressed air, for example, where an air compressor may already be present on a drilling site when compressed air is being used as the drilling fluid. The compressed air enters via compressed air line 18 via pressure intake 20. Compressed air line 18 may be connected to a t-connector 17 where, in one embodiment, the top of the t-connector is also attached to air line 14A and the bottom of the t-connector is attached to air line 14B. The compressed air passes through air line 18 and, optionally, through pressure regulator 2C, and is received by vacuum pump 7 to drive the vacuum pump 7. In the alternative, electricity or other energy source could be used to drive the vacuum pump. Check valve 8 allows for the removal of gases present in the vacuum pump 7 to be released through discharge 15.

Discharge 15 can also be provided to discharge the first gas flow and second gas flow that have passed through the first infrared gas sensor 5A and the second infrared gas sensor 5B, respectively.

Although a first testing circuit 12A and second testing circuit 12B are shown in FIG. 1, a person skilled in the art will appreciate that more testing circuits could be incorporated to monitor additional gas flows.

In one embodiment, the first and second filters 1A and 1B can be flushed out to remove any debris stuck to the filter such as drill cuttings, dust, etc. which may interfere in the flow of gases therethrough. In this instance, each sample line 13A and 13B is provided with pressure differential sensors 9A and 9B, respectively, which pressure differential sensors operate to detect a change in pressure in sample lines 13A and 13B due to the filters 1A and/or 1B becoming clogged with debris. Thus, when the pressure differential reaches a certain point, the filters 1A and 1B can be back flushed as follows. Valves 19A and 19B, which valves are in the open position when the system is in operation, are both closed and valves 23A and 23B, which valves are also in the open position when the system is in operation, are also closed. Valves 16A and 16B, which valves are in the closed position when the system is in operation, are then opened to allow compressed air to flow through lines 14A and 14B, respectively, and then to first and second filters 1A and 1B, respectively. Valves 21A and 21B are then opened to allow the cuttings, dust and other debris collected on the filters to exit via lines 28A and 28B, respectively, and ultimately through outlet 15. In operation, the system 10 can be used to test gas flows from two different sources and determine the percentage concentration of hydrocarbon gas/volume of air. The first inlet 11A of the first testing circuit 12A can be connected to a first gas source and the second inlet 11B of the second testing circuit 12B can be connected to the second gas source. As the first and second testing circuit 12A, 12B receive gas from the first and second gas sources, respectively, these gas flows from these sources can be set to a standardized pressure and a standardized flow rate before passing through the respective first and second infrared gas sensor 5A, 5B. With the first gas flow and the second gas flow standardized with respect to pressure and flow rate before passing through the first infrared sensor 5A and the second infrared sensor 5B, respectively, the measurements taken over time can be related to each other. If the level of hydrocarbon gas gets too great, the control box 80 can trigger an alarm. The alarm can include and audible alarm and/or a visible alarm, such as a strobe light, etc. to alert people to the elevated levels of hydrocarbon gases.

By way of example, when measuring methane concentrations during drilling in coal bed methane deposits it is important for the drilling crew to be alerted when the methane concentration reaches about 5% by volume, as methane is flammable in the range of about 5% to about 15% in air. Thus, when amounts reach 5% methane in air, the alarm system will alert the drilling crew and drilling can be stopped to consider whether to use a modified drilling technique at this point.

With reference now to FIG. 2, the signals produced in sensors 5A and 5B (generally between 4-20 mA) are transmitted to a master gas detection system controller 80, for example a CR-4000 Controller™ or a HA71 Digital Gas Controller™. The controller 80 accepts 4-20 mA signal input from any 4-20 mA gas transmitter. The controller 80 is equipped with a power plug 82 and wireless antenna 86. The controller 80 may have a digital display 85, which can display information such as the percent methane gas in air, etc. The controller 80 may also be hooked up to a computer (not shown) which can receive the data from the controller, store the data and plot out the data in real time (e.g., methane concentrations).

Controller 80 may comprise one or more sensor connectors 79, which, in turn, are connected to a variety of sensors for receiving data signals. As shown in FIG. 2, in this embodiment, controller 80 comprises eight sensor connectors 79. One sensor connector is hard wired to infrared sensor 5A and another sensor connector is hardwired to infrared sensor 5B. Two of the sensor connectors are hardwired to pressure differential sensors 9A and 9B, respectively. The other four sensor connectors may be hardwired to other areas of the drilling rig, for example, to the surface blowout preventer, the drilling rig floor, the drill pipe racks and the air trailer, for additional methane gas monitoring for safety purposes.

It is understood that the controller 80 can be equipped with either an audio alarm (not shown) or a flashing light 84, which alarms tell the operators, for example, that the level of methane is greater than 5% by volume air. The digital display 85 will also simultaneously display the monitored data as trends, bar graphs and engineering units. The controller can be programmed as is known in the art using control buttons 88.

The controller 80 can also be wirelessly connected to a second controller that can be placed in, for example, the well site supervisor's shack. This enables the supervisor to have instant access to all monitoring and alarm information as it happens. The real time information enables the supervisor to be more cost effective and efficient in the drilling operations.

The system 10 can be used for a number of different applications; however, in one aspect, it can be used to continuously monitor a well being drilled using reverse circulation drilling techniques for elevated levels of hydrocarbon gas, such as methane. Reverse circulation drilling has been developed to drill oil and gas wells and has several advantages over conventional drilling. Conventional drilling techniques typically circulate drilling fluid, such as drilling mud, down a drill pipe string or string of coiled tubing where it is used with a drill bit to drill the well. The drilling fluid picks up cuttings that have been removed from the rock of the well by the drill bit and then the drilling fluid containing the cuttings is re-circulated to the ground surface through the annulus formed between the well bore and the drill pipe string or coiled tubing string. In reverse circulation drilling, the drilling fluid is re-circulated so that it does not come in contact with the inner walls of the well bore, but rather remains isolated from the walls of the well bore, unlike in conventional drilling techniques. A dual wall drill pipe or dual wall coil tubing is used. The dual wall drill pipe or dual wall coil tubing is formed of an outer pipe/tubing and an inner pipe/tubing so that there is an inner passageway formed within the inner pipe/tubing of the drill pipe or coil tubing and an annulus formed between the outer pipe/tubing and the inner pipe/tubing. This dual wall drill pipe or dual wall coil tubing can be constructed by running a smaller diameter drill pipe or coil tubing inside a larger diameter drill pipe or coil tubing. The drill fluid is then run down hole through either the inner passageway formed by the inner pipe/tubing of the dual wall drill pipe or dual wall coil tubing or the annulus formed between the inner pipe/tubing and outer pipe/tubing and then once the drilling fluid has reached the bottom of the well, is recirculated back up to the ground surface through the other of the inner passageway or the annulus of the drill pipe or coiled tubing. In this manner, the drilling fluid can be recirculated back up to the ground surface without it coming into contact with the inner walls of the well bore.

FIG. 2 illustrates a drilling rig 140 for drilling an oil/gas well 150 using a reverse circulation drilling method, with the gas monitoring system 10 connected to monitor for elevated levels of hydrocarbon gas reaching the top of the well 150 coming from two separate areas.

The drilling rig 140 can include a dual wall drill pipe string 142 containing and inner pipe 146 and an outer pipe 144 that is run down hole into the well 150 to drill the well. Drilling fluid can be run down hole through either the inner passageway 147 of the inner drill pipe 146 or through the annulus 148 formed between the inner pipe 146 and the outer pipe 144. Preferably, when drilling in coal bed methane formations, the drilling fluid used is pressurized air. Once the drilling fluid has reached the bottom of the well 150 and collected cuttings, the used drilling fluid can be recirculated up to the ground surface the through other of the annulus 148 between the inner pipe 146 and the outer pipe 144 or through the inner passageway 147 of the inner pipe 146, whichever one the drilling fluid is not being provided down. Once at the ground surface, the used drilling fluid will be routed out of the well 150 through a discharge line to a blewie line 149 to be dealt with by disposal in a pit, recycling, flaring, etc.

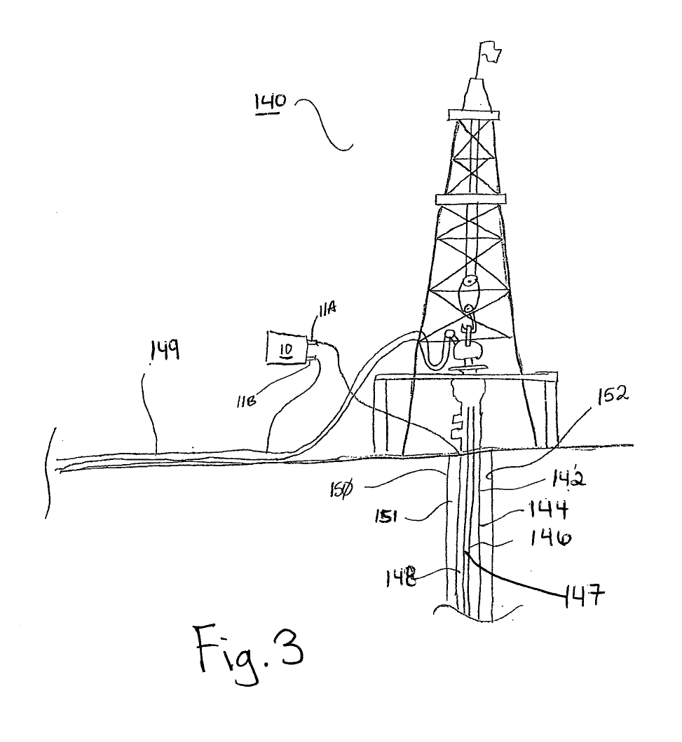

Referring now to FIGS. 1, 2, and 3, the dual hydrocarbon gas monitoring system 10 can be used to monitor the concentrations of hydrocarbon gas in the well 150 as follows. The first inlet 11A can be connected by the back side casing pressure of the well bore annulus 151 between a well bore 152 of the well 150 and the outer pipe 144 of the dual wall drill string 142. The second inlet 11B can be connected to the blewie line 149 carrying away the exhausted drilling fluid. In this manner, the monitoring system 10 can continuously monitor the concentration of a hydrocarbon gas, such as methane, in both the passage where drilling fluid is being recirculated back out of the well 150 from the bottom of the well 150 and from inside the well bore annulus 151 near the top of the well 150. If the gas flows obtained from either of these sources start to have a concentration of hydrocarbon gas above a desired level, the monitoring system 10 can sound an alarm, notifying the crew of the drilling rig 140 to this fact.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A system for monitoring the amount of a selected gas in a gas flow, the system comprising:
a gas sensor for sensing the selected gas in the gas flow and producing a corresponding electrical signal;
at least one pressure regulator to adjust a pressure of the gas flow to a standardized pressure before the gas flow reaches the gas sensor;
a flow adjustment device to adjust a flow rate of the gas flow to a standardized flow rate before the gas flow reaches the gas sensor; and
a controller for receiving the electrical signal from the gas sensor and processing the electric signal to calculate the concentration of the selected gas in the gas flow.

2. The system as claimed in claim 1, the controller further comprising an alarm, whereby when the selected gas concentration reaches a pre-set intensity, the alarm is triggered.

3. The system as claimed in claim 2, wherein the alarm is an audio alarm.

4. The system as claimed in claim 2, wherein the alarm is a visual alarm.

5. The system as claimed in claim 2, wherein the selected gas is methane and the pre-set intensity is in the range of about 5% to about 15% methane by volume per volume gas flow.

6. The system as claimed in claim 1, wherein the concentration of the selected gas is calculated in percent of the selected gas by volume per volume gas flow.

7. The system as claimed in claim 1, wherein the controller processes the electric signal in real time.

8. The system as claimed in claim 1 further comprising a filter for filtering the gas flow to remove debris when the gas flow first enters the system.

9. The system as claimed in claim 1 further comprising a water separator positioned between the at least one pressure regulator and the flow adjustment device for removing any moisture contained in the gas flow.

10. The system as claimed in claim 8 further comprising a pressure differential sensor to detect when the filter is clogged with debris, whereby when the filter is clogged with debris the filter is back flushed with a fluid.

11. The system as claimed in claim 10, wherein the fluid is air.

12. The system as claimed in claim 1 further comprising a computer for receiving the data from the controller, storing the data and/or plotting out the data in real time

13. A system for monitoring the amount of a selected gas in at least two gas flows comprising:
a separate gas sensor for each gas flow for sensing the concentration of the selected gas in each gas flow and producing at a corresponding electrical signal for each gas flow;
at least one pressure regulator for each gas sensor to adjust a pressure of each gas flow to a standardized pressure before the gas flows reach their respective gas sensors;
a flow adjustment device for each gas sensor to adjust a flow rate of each gas flow to a standardized flow rate before the gas flows reach their respective gas sensors; and
a controller for receiving each electrical signal from each gas sensor and processing the electric signals to calculate the concentration of the selected gas in each gas flow.

14. The system as claimed in claim 13, the controller further comprising an alarm, whereby when the selected gas concentration reaches a pre-set intensity in either gas flow, the alarm is triggered.

15. The system as claimed in claim 14, wherein the alarm is an audio alarm.

16. The system as claimed in claim 15, wherein the alarm is a visual alarm.

17. The system as claimed in claim 16, wherein the selected gas is methane and the pre-set intensity is in the range of about 5% to about 15% methane by volume per volume gas flow.

18. The system as claimed in claim 13, wherein the concentration of the selected gas is calculated in percent of the selected gas by volume per volume gas flow.

19. The system as claimed in claim 13, wherein the controller processes the electric signal in real time.

20. The system as claimed in claim 13 further comprising a filter for each of the gas flows for filtering debris from the gas flows as they first enter the system.

21. The system as claimed in claim 13 further comprising a water separator positioned between the at least one pressure regulator and the flow adjustment device of each sensor for removing any moisture contained in the gas flows.

22. The system as claimed in claim 20 further comprising a pressure differential sensor to detect when the filters are clogged with debris, whereby when the filters are clogged with debris the filters are back flushed with a fluid.

23. The system as claimed in claim 22, wherein the fluid is air.

24. A method for continuously monitoring the amount of a selected gas in a gas flow produced during an operation, comprising:
adjusting a pressure of the gas flow to a standardized pressure;
adjusting a flow rate of the standardize pressure gas flow to a standardized flow rate;
directing the flow rate standardized gas flow into a gas sensor and sensing the concentration of the selected gas in the gas flow to produced at a corresponding electrical signal; and
receiving the electrical signal from the gas sensor and processing the electric signals to calculate the concentration of the selected gas in the gas flow.

25. The method as claimed in claim 24, wherein the operation is a drilling operation for drilling an oil or gas well and the gas flow is flowing from the oil or gas well through a drill pipe, an annulus formed between the drill pipe and the oil or gas well, a surface blowout preventer, a drilling rig floor, a pipe rack and/or an air trailer.

26. The method as claimed in claim 24 further comprising activating an alarm when the concentration of the selected gas in the gas flow reaches a pre-set intensity.

27. The method as claimed in claim 26, wherein the selected gas is methane and the pre-set intensity is in the range of about 5% to about 15% methane by volume per volume gas flow.

28. The method as claimed in claim 25 further comprising continuously storing and plotting the concentration of the selected gas in the gas flow.

29. The method as claimed in claim 25 further comprising filtering the gas flow to remove debris from the gas flow prior to adjusting a pressure of the gas flow to a standardized pressure.

30. The method as claimed in claim 25 further comprising separating out any water after adjusting a pressure of the gas flow to a standardized pressure but before adjusting a flow rate of the standardize pressure gas flow to a standardized flow rate to remove any moisture contained in the standardized pressure gas flow.

31. The method as claimed in claim 29 further comprising detecting when the filters are clogged with debris and back flushing the clogged filters with a fluid.

32. The method as claimed in claim 31, wherein the fluid is air.

33. The method as claimed in claim 24, wherein the operation is a drilling operation for drilling an oil or gas well and the drilling of the oil or gas well is performed using a concentric drill pipe and wherein the gas flow is flowing from an annulus formed between the concentric drill pipe and the oil or gas well.

34. The method as claimed in claim 24, wherein the operation is a drilling operation for drilling an oil or gas well and the drilling of the oil or gas well is performed using a concentric drill pipe comprising an inner pipe and an outer pipe and wherein the gas flow is flowing from either an annulus formed between the inner and outer pipes or a passageway in the inner pipe.
